(19) United States
(12) Patent Application Publication
(10) Pub. No.: US 2017/0322621 A1
(43) Pub. Date: Nov. 9, 2017

(54) MOBILE PHONE, METHOD FOR OPERATING MOBILE PHONE, AND RECORDING MEDIUM

(71) Applicant: KYOCERA CORPORATION, Kyoto (JP)

(72) Inventors: Kaori UEDA, Yokohama-shi (JP); Atsushi TAMEGAI, Yokohama-shi (JP)

(21) Appl. No.: 15/660,699

(22) Filed: Jul. 26, 2017

Related U.S. Application Data
(63) Continuation of application No. PCT/JP2016/051256, filed on Jan. 18, 2016.

(30) Foreign Application Priority Data
Jan. 28, 2015 (JP) 2015-014307

(51) Int. Cl. G06F 3/01; G10L 15/26; H04W 4/04; H04M 1/03; G06F 3/044; G10L 15/18

(52) U.S. Cl. CPC G06F 3/011; H04W 4/04; H04M 1/03; G10L 15/265; G10L 15/18; G06F 3/044

(57) ABSTRACT

A mobile phone, a method for operating a mobile phone, and a recording medium are disclosed. In one embodiment, a mobile phone comprises a wireless communicator, a proximity detector, and at least one processor. The wireless communicator is configured to receive information from an input apparatus external to the mobile phone. The proximity detector is configured to detect an object in proximity. The at least one processor is configured to perform a voice call with a first phone apparatus external to the mobile phone and activate an input from the input apparatus when the proximity detector detects the object in proximity and the at least one processor performs the voice call.

### CROSS-REFERENCE TO RELATED APPLICATION

The present application is a continuation based on PCT Application No. PCT/JP2016/051256, filed on Jan. 18, 2016, which claims the benefit of Japanese Application No. 2015-014037, filed on Jan. 28, 2015. PCT Application No. PCT/JP2016/051256 is entitled “PORTABLE TELEPHONE” and Japanese Application No. 2015-014307 is entitled “MOBILE PHONE”. The contents of which are incorporated by reference herein in their entirety.

### FIELD

Embodiments of the present disclosure relate to mobile phones.

### BACKGROUND

Terminals and ring-shaped input apparatuses for terminals have been proposed. Such a ring-shaped input apparatus is to be worn by a user on his or her finger and can transmit the movement of the finger to the terminal. The terminal performs processing corresponding to the movement of the finger.

### SUMMARY

A mobile phone, a method for operating a mobile phone, and a recording medium are disclosed. In one embodiment, a mobile phone comprises a wireless communicator, a proximity detector, and at least one processor. The wireless communicator is configured to receive information from an input apparatus external to the mobile phone. The proximity detector is configured to detect an object in proximity thereof. The at least one processor is configured to perform a voice call with a first phone apparatus external to the mobile phone and activate an input from the input apparatus in response to detection of the object when the at least one processor performs the voice call.

In another embodiment, a method for operating a mobile phone comprises receiving information from an input apparatus external to the mobile phone. An object in proximity is detected. A voice call is performed with a first phone apparatus external to the mobile phone. When the object in proximity is detected and the voice call is performed, an input from the input apparatus is enabled.

In still another embodiment, a non-transitory computer readable recording medium stores a control program so as to cause a mobile phone to receive information from an input apparatus external to the mobile phone. The mobile phone detects an object in proximity. The mobile phone performs a voice call with a first phone apparatus external to the mobile phone. When the object in proximity is detected and the voice call is performed, the mobile phone enables an input from the input apparatus.

### BRIEF DESCRIPTION OF THE DRAWINGS

FIG. 1 schematically illustrates an example of a mobile phone system.

FIG. 2 schematically illustrates an example of the internal configuration of a wearable input apparatus.

FIG. 3 illustrates a schematic rear view of an example of the external appearance of a mobile phone.

FIG. 4 schematically illustrates an example of the internal electrical configuration of the mobile phone.

FIG. 5 schematically illustrates an example of the internal configuration of a controller.

FIG. 6 schematically illustrates an example of an incoming call screen.

FIGS. 7, 8, and 9 each schematically illustrate an example of the spatial movement of the wearable input apparatus.

FIG. 10 illustrates a flowchart showing an example of the action performed by the controller.

FIG. 11 schematically illustrates an example of the internal electrical configuration of the mobile phone.

FIG. 12 schematically illustrates an example of an ongoing call screen.

FIG. 13 illustrates a flowchart showing an example of the action performed by the controller.

FIG. 14 schematically illustrates an example of the mobile phone system.

FIG. 15 illustrates a flowchart showing an example of the action performed by the controller.

FIG. 16 schematically illustrates an example of the mobile phone system.

FIGS. 17, 18, and 19 each illustrate a flowchart showing an example of the action performed by the controller.

FIG. 20 schematically illustrates an example of the internal configuration of the controller.

FIGS. 21 to 25 each illustrate a flowchart showing an example of the action performed by the controller.

FIGS. 26 and 27 each schematically illustrate an example of a call end screen.

FIGS. 28 and 29 each schematically illustrate an example of the internal configuration of the controller.

FIG. 30 schematically illustrates an example of the input and output done by a string correction unit.

### DETAILED DESCRIPTION

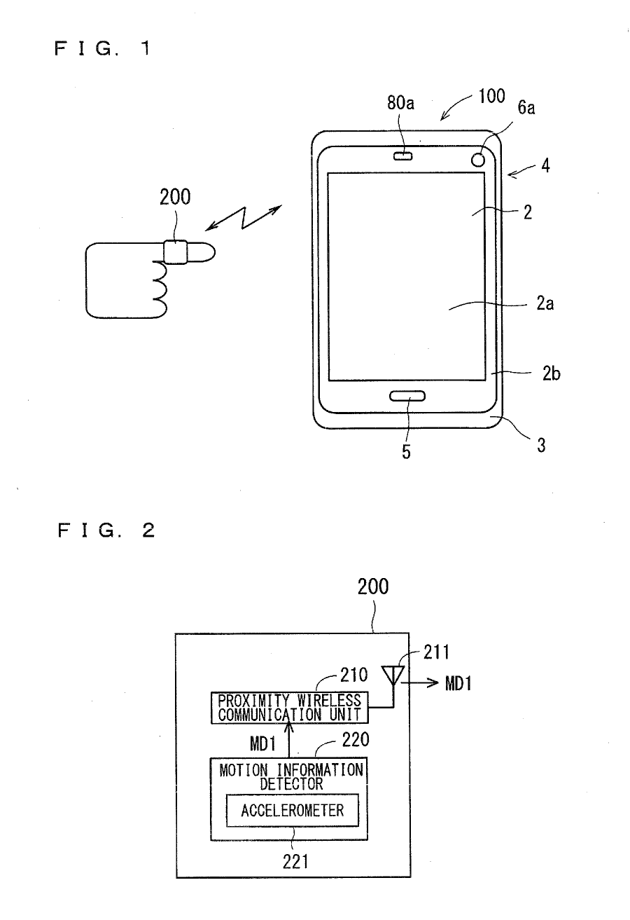

FIG. 1 schematically illustrates an example configuration of a mobile phone system. In the illustration of FIG. 1, the mobile phone system includes a mobile phone 100 and a wearable input apparatus 200. The mobile phone 100 and the wearable input apparatus 200 wirelessly communicate with each other. In this mobile phone system, a user can use the wearable input apparatus 200 to perform an input to the mobile phone 100, as will be described below. That is, the wearable input apparatus 200 can transmit, to the mobile phone 100, information input to the mobile phone 100, and then, the mobile phone 100 performs the action corresponding to the input information. The user can operate the mobile phone 100 while being apart from the mobile phone 100. The mobile phone 100 according to one embodiment may be an electronic apparatus having the phone call function. Examples of the mobile phone 100 include a tablet, a personal digital assistant (PDA), a smartphone, a portable music player, or a personal computer.

The wearable input apparatus 200 is to be worn by the user on, for example, his or her operator body part. In the illustration of FIG. 1, the operator body part is a finger, and the wearable input apparatus 200 has a ring shape as a whole. The user slips the wearable input apparatus 200 on the finger. The wearable input apparatus 200 is thus worn by the user. The user can spatially move the wearable input apparatus 200. Note that the wearable input apparatus 200 does not necessarily have a ring shape and may be, for example, a single-perforated tube, which can be worn by the user on his or her finger. In this case, the user inserts his or her fingertip into the opening of the tube. The wearable input apparatus 200 is thus worn by the user. Alternatively, the wearable input apparatus 200 may include a belt member such that the user can wear the wearable input apparatus 200 on, for example, his or her au u. In short, the wearable input apparatus 200 may have any shape or may include any attaching member so as to be worn by the user.

FIG. 2 schematically illustrates an example of the internal electrical configuration of the wearable input apparatus 200. The wearable input apparatus 200 includes, for example, a proximity wireless communication unit (a proximity wireless communicator) 210 and a motion information detector 220.

The proximity wireless communication unit 210 includes an antenna 211 and can perform proximity wireless communication with the mobile phone 100 through the antenna 211. The proximity wireless communication unit 210 can conduct communication according to the Bluetooth (registered trademark) or the like.

The motion information detector 220 can detect motion information MD1 indicative of the spatial movement of the wearable input apparatus 200. The wearable input apparatus 200 is worn on the operator body part, and thus, the motion information MD1 is also indicative of the movement of the operator body part. The following description will be given assuming that the spatial movement of the wearable input apparatus 200 is equivalent to the movement of the operator body part.

The motion information detector 220 includes, for example, an accelerometer 221. The accelerometer 221 can obtain acceleration components in three orthogonal directions repeatedly at, for example, predetermined time intervals. The position of the wearable input apparatus 200 (the position of the operator body part) can be obtained by integrating acceleration twice with respect to time, and thus, the chronological data including values detected by the accelerometer 221 describes the movement of the operator body part. Here, the chronological data on the acceleration components in three directions is used as an example of the motion information MD1. Alternatively, the movement of the wearable input apparatus 200 may be identified based on the chronological data, and then, information on the movement may be used as the motion information MD1.

The motion information detector 220 can transmit the detected motion information MD1 to the mobile phone 100 through the proximity wireless communication unit 210. The motion information MD1 is an example of the above-mentioned input information.

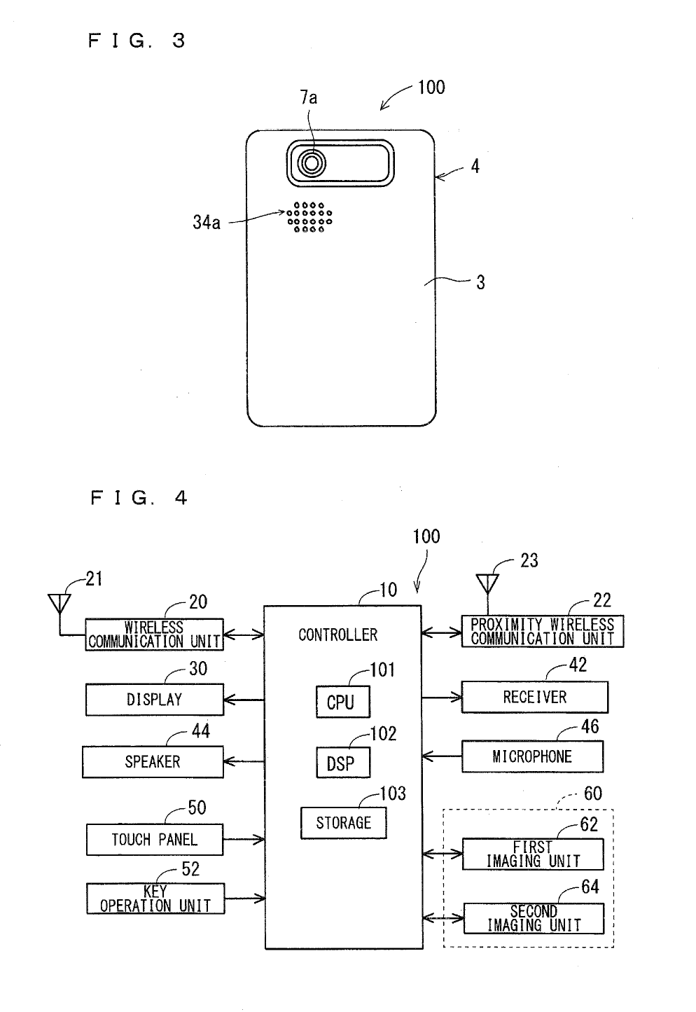

FIG. 1 illustrates the external appearance of the mobile phone 100 as viewed from the front surface side. FIG. 3 illustrates a rear view of the external appearance of the mobile phone 100. The mobile phone 100 can communicate with another communication device directly or via, for example, a base station and a server.

As illustrated in FIGS. 1 and 3, the mobile phone 100 includes a cover panel 2 and a case part 3. The combination of the cover panel 2 and the case part 3 forms a housing 4 (hereinafter also referred to as an “apparatus case”) having, for example, an approximately rectangular plate shape in a plan view.

The cover panel 2, which may have an approximately rectangular shape in a plan view, is the portion other than the periphery in the front surface part of the mobile phone 100. The cover panel 2 is made of, for example, transparent glass or a transparent acrylic resin. In some embodiments, the cover panel 2 is made of, for example, sapphire. Sapphire is a single crystal based on aluminum oxide (Al₂O₃). Herein, sapphire refers to a single crystal having a purity of Al₂O₃ of approximately 90% or more. The purity of Al₂O₃ is preferably greater than or equal to 99%, which provides a greater resistance to damage of the cover panel. The cover panel 2 may be made of materials other than sapphire, such as diamond, zirconia, titania, crystal, lithium tantalite, and aluminum oxynitride. Similarly to the above, each of these materials is preferably a single crystal having a purity of approximately 90% or more, which provides a greater resistance to damage of the cover panel.

The cover panel 2 may be a multilayer composite panel (laminated panel) including a layer made of sapphire. For example, the cover panel 2 may be a double-layer composite panel including a layer of sapphire (a sapphire panel) located on the surface of the mobile phone 100 and a layer of glass (a glass panel) laminated on the sapphire panel. The cover panel 2 may be a triple-layer composite panel including a layer of sapphire (a first sapphire panel) located on the surface of the mobile phone 100, a layer of glass (a glass panel) laminated on the first sapphire panel, and another layer of sapphire (a second sapphire panel) laminated on the glass panel. The cover panel 2 may also include layers made of crystalline materials other than sapphire, such as diamond, zirconia, titania, crystal, lithium tantalite, and aluminum oxynitride.

The case part 3 forms the periphery of the front surface part, the side surface part, and the rear surface part of the mobile phone 100. The case part 3 is made of, for example, a polycarbonate resin.

The front surface of the cover panel 2 includes a display area 2a on which various pieces of information such as characters, signs, graphics, or images are displayed. The display area 2a has, for example, a rectangular shape in a plan view. A peripheral part 2b surrounding the display area 2a in the cover panel 2 is black because of a film or the like laminated thereon, and thus, is a non-display part on which no information is displayed. Attached to a rear surface of the cover panel 2 is a touch panel 50, which will be described below. The user can provide various instructions to the mobile phone 100 by operating the display area 2a on the front surface of the mobile phone 100 with a finger or the like. Also, the user can provide various instructions to the mobile phone 100 by operating the display area 2a with, for example, a pen for capacitive touch panel such as a stylus pen, instead of the operator such as the finger.

The apparatus case 4 houses, for example, at least one operation key 5. The operation key 5 is, for example, a hardware key and is located in, for example, the lower edge portion of the front surface of the cover panel 2.

The touch panel 50 and the operation key 5 constitute an input unit for use in performing an input to the mobile phone 100.

FIG. 4 illustrates a block diagram showing the electrical configuration of the mobile phone 100. As illustrated in FIG. 4, the mobile phone 100 includes a controller 10, a wireless communication unit (a wireless communicator) 20, a proximity wireless communication unit (a proximity wireless communicator) 22, a display 30, a first sound output unit (receiver) 42, a second sound output unit (speaker) 44, a microphone 46, the touch panel 50, a key operation unit 52, and an imaging unit 60. The apparatus case 4 houses these constituent components of the mobile phone 100.

The controller 10 includes, for example, a central processing unit (CPU) 101, a digital signal processor (DSP) 102, and a storage 103. The controller 10 can control other constituent components of the mobile phone 100 to perform overall control of the action of the mobile phone 100. The storage 103 includes, for example, read only memory (ROM) and random access memory (RAM). The storage 103 can store, for example, a main program and a plurality of application programs (also merely referred to as “applications” hereinafter). The main program is a control program for controlling the action of the mobile phone 100, specifically, the individual constituent components of the mobile phone 100 such as the wireless communication unit 20 and the display 30. The CPU101 and the DSP 102 execute the various programs stored in the storage 103 to achieve various functions of the controller 10. Although one CPU 101 and one DSP 102 are illustrated in FIG. 4, a plurality of CPUs 101 and a plurality of DSPs 102 may be included in the controller 10. The CPUs 101 and the DSPs 102 may cooperate with one another to achieve various functions. Although the storage 103 is shown inside the controller 10 in FIG. 4, the storage 103 may be located outside the controller 10. That is to say, the storage 103 may be separate from the controller 10. All or some of the functions of the controller 10 may be performed by hardware.

The wireless communication unit 20 includes an antenna 21. The wireless communication unit 20 can receive a signal from another mobile phone or a signal from a communication device such as a web server connected to the Internet through the antenna 21 via a base station or the like. The wireless communication unit 20 can amplify and down-convert the received signal and then output a resultant signal to the controller 10.

The controller 10 can, for example, demodulate the received signal. Further, the wireless communication unit 20 can up-convert and amplify a transmission signal generated by the controller 10 to wirelessly transmit the processed transmission signal through the antenna 21. The transmission signal from the antenna 21 is received, via the base station or the like, by another mobile phone or a communication device connected to the Internet.

The proximity wireless communication unit 22 includes an antenna 23. The proximity wireless communication unit 22 can conduct, through the antenna 23, communication with a communication terminal that is closer to the mobile phone 100 than the communication target of the wireless communication unit 20 (e.g., a base station) is. For example, the proximity wireless communication unit 22 can communicate with the wearable input apparatus 200. The proximity wireless communication unit 22 can conduct communication according to, for example, the Bluetooth (registered trademark) standard.

The display 30 is, for example, a liquid crystal display panel or an organic electroluminescent (EL) panel. The display 30 can display various pieces of information such as characters, signs, graphics, or images under the control of the controller 10. The information displayed on the display 30 is displayed on the display area 2a on the front surface of the cover panel 2. In other words, the display 30 displays information on the display area 2a.

The touch panel 50 can detect an operation performed on the display area 2a of the cover panel 2 with the operator such a as a finger. The touch panel 50 is, for example, a projected capacitive touch panel and is attached to the rear surface of the cover panel 2. When the user performs an operation on the display area 2a of the cover panel 2 with the operator such as the finger, a signal corresponding to the operation is input from the touch panel 50 to the controller 10. The controller 10 can identify, based on the signal from the touch panel 50, the purpose of the operation performed on the display area 2a and accordingly perform processing appropriate to the purpose.

The key operation unit 52 can detect a press down operation performed on the individual operation key 5. The key operation unit 52 can determine whether the individual operation key 5 is pressed down. When the operation key 5 is not pressed down, the key operation unit 52 outputs, to the controller 10, a non-operation signal indicating that no operation is performed on the operation key 5. When the operation key 5 is pressed down, the key operation unit 52 outputs, to the controller 10, an operation signal indicating that an operation is performed on the operation key 5. The controller 10 can thus determine whether an operation is performed on the individual operation key 5.

The receiver 42 can output a received sound and is, for example, a dynamic speaker. The receiver 42 can convert an electrical sound signal from the controller 10 into a sound and then output the sound. The sound output from the receiver 42 is output to the outside through a receiver hole 80a in the front surface of the mobile phone 100. The volume of the sound output through the receiver hole 80a is set to be lower than the volume of the sound output from the speaker 44 through speaker holes 34a.

In place of the receiver 42, a piezoelectric vibration element may be included as the first sound output unit. The piezoelectric vibration element can vibrate based on a sound signal under the control of the controller 10. The piezoelectric vibration element is located on, for example, the rear surface of the cover panel 2. The piezoelectric vibration element can cause, through its vibration based on the sound signal, the cover panel 2 to vibrate. The vibration of the cover panel 2 is transmitted to the user's ear as a voice. The receiver hole 80a is not necessary for this configuration.

The speaker 44 is, for example, a dynamic speaker. The speaker 44 can convert an electrical sound signal from the controller 10 into a sound and then output the sound. The sound output from the speaker 44 is output to the outside through the speaker holes 34a in the rear surface of the mobile phone 100. The sound output through the speaker holes 34a is set to a volume such that the sound can be heard in the place apart from the mobile phone 100. That is, the volume of the sound output through the second sound output unit (speaker) 44 is higher than the volume of the sound output through the first sound output unit (the speaker 44 or the piezoelectric vibration element).

The microphone 46 can convert the sound from the outside of the mobile phone 100 into an electrical sound signal and then output the electrical sound signal to the controller 10. The sound from the outside of the mobile phone 100 is, for example, taken inside the mobile phone 100 through the microphone hole in the front surface of the cover panel 2, and then, is received by the microphone 46.

The imaging unit 60 includes, for example, a first imaging unit 62 and a second imaging unit 64. The first imaging unit 62 includes, for example, an imaging lens 6a and an image sensor. The first imaging unit 62 can capture a still image and a video under the control of the controller 10. As illustrated in FIG. 1, the imaging lens 6a is located in the front surface of the mobile phone 100. Thus, the first imaging unit 62 can capture an image of an object located on the front surface side (the cover panel 2 side) of the mobile phone 100.

The second imaging unit 64 includes, for example, an imaging lens 7a and an image sensor. The second imaging unit 64 can capture a still image and a video under the control of the controller 10. As illustrated in FIG. 3, the imaging lens 7a is located in the rear surface of the mobile phone 100. Thus, the second imaging unit 64 can capture an image of an object located on the rear surface side of the mobile phone 100.

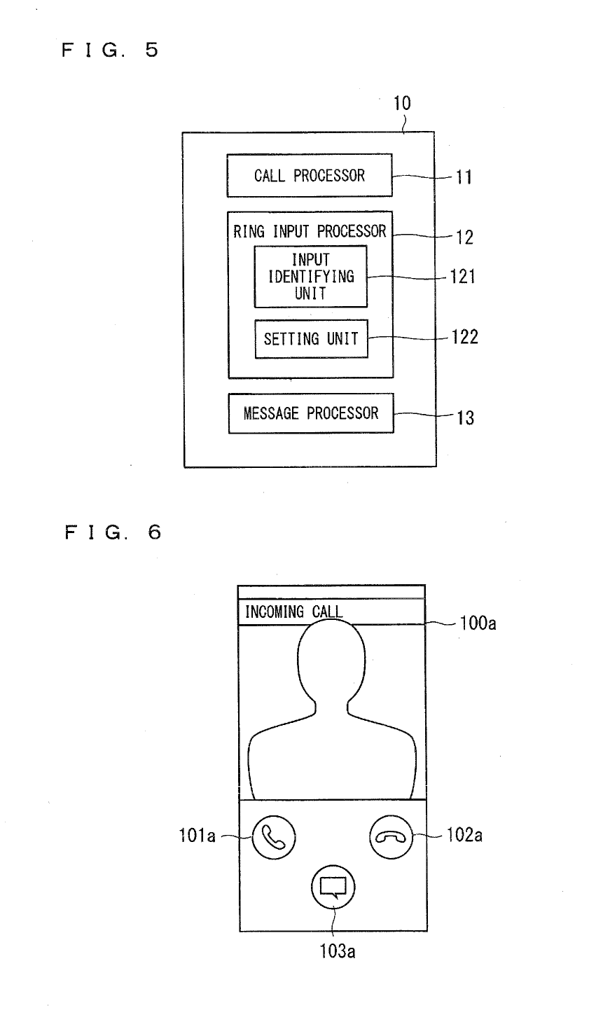

FIG. 5 illustrates a functional block diagram schematically showing an example of the internal configuration of the controller 10. The controller 10 includes, for example, a call processor 11, a ring input processor 12, and a message processor 13. The functional units of the controller 10 may be implemented by, for example, executing programs stored in the storage 103. All or some of these functional units may be implemented by hardware. This holds true for other functional units, which will be described below, and will not be further elaborated in the following description.

The call processor 11 can execute call processing associated with a voice call performed with another phone apparatus. For example, the call processor 11 can transmit an outgoing call signal for making a call to another phone apparatus via the wireless communication unit 20, and can receive an incoming call signal indicative of an incoming call from another phone apparatus. The call processor 11 can also transmit, to another phone apparatus, a sound signal input through the microphone 46, and can output, through the receiver 42, a sound signal received from another phone apparatus.

In addition, while performing a voice call with a first phone apparatus, the call processor 11 can receive an incoming call signal from a second phone apparatus different from the first phone apparatus (hereinafter referred to as an “incoming call waiting to be answered”). When there is an incoming call waiting to be answered, the call processor 11 provides a notification to the user, thereby prompting the user to make a response. The user can answer or reject the incoming call waiting to be answered.

FIG. 6 schematically illustrates an example of an incoming call screen 100a displayed when there is an incoming call waiting to be answered. The call processor 11 causes the display 30 to display the incoming call screen 100a. The incoming call screen 100a shows, for example, an “answer” button 101a, a “reject” button 102a, and a “message transmission” button 103a. The “answer” button 101a is a button for use in initiating a voice call with the second phone apparatus. The “reject” button 102a is a button for use in rejecting the call from the second phone apparatus. The “message transmission” button 103a is a button for use in transmitting a message to the second phone apparatus.

When the user performs an operation on the button 101a, the operation is detected by the touch panel 50, and then, the information is input to the call processor 11. This operation may be the act of bringing the operator (e.g., a finger) close to the display area 2a and subsequently moving the operator away from the display area 2a (a “tap operation”). The same holds true for other operations which will be described below. Upon receipt of the information, the call processor 11 places the voice call with the first phone apparatus on hold, and then, initiates a voice call with the second phone apparatus.

When the user performs an operation on the button 102a, the operation is detected by the touch panel 50, and then, the information is input to the call processor 11. Upon receipt of the information, the call processor 11 rejects the call from the second phone apparatus.

When the user performs an operation on the button 103a, the operation is detected by the touch panel 50, and then, the information is input to the call processor 11. Upon receipt of the information, the call processor 11 outputs information on the address of the second phone apparatus to the message processor 13. Examples of the address information include the telephone number of the second phone apparatus. The telephone number is contained in, for example, the incoming call signal.

The message processor 13 can execute processing for transmitting a message to the second phone apparatus. For example, the message processor 13 causes the display 30 to display a screen on which the user can input a message. The screen shows, for example, an input button for use in inputting a message and a transmission button for use in transmitting the message. The user can operate the input button, as appropriate, to input a message. For example, the user inputs a message saying “I will call you back later”. After inputting the message, the user operates the transmission button, so that the message processor 13 transmits the message to the second phone apparatus. Examples of the function of message transmission include the email function.

Upon receipt of the message, the second phone apparatus displays the message on its own display. This makes the user of the second phone apparatus aware of the intention expressed by the user of the mobile phone 100.

The ring input processor 12 includes an input identifying unit 121 and a setting unit 122. The input identifying unit 121 can receive, via the proximity wireless communication unit 22, the motion information MD1 from the wearable input apparatus 200 and identify the input represented as the motion information MD1. For example, the correspondence between the motion information MD1 and the relevant input is determined in advance and prestored in a storage (e.g., the storage 103). The input is identified based on the correspondence and the received motion information MD1.

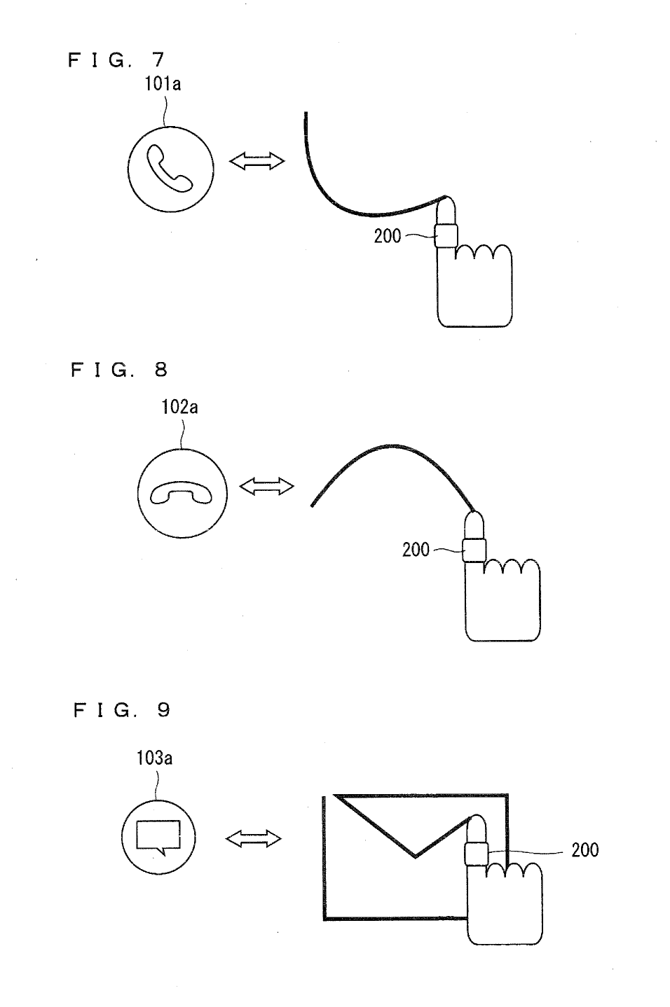

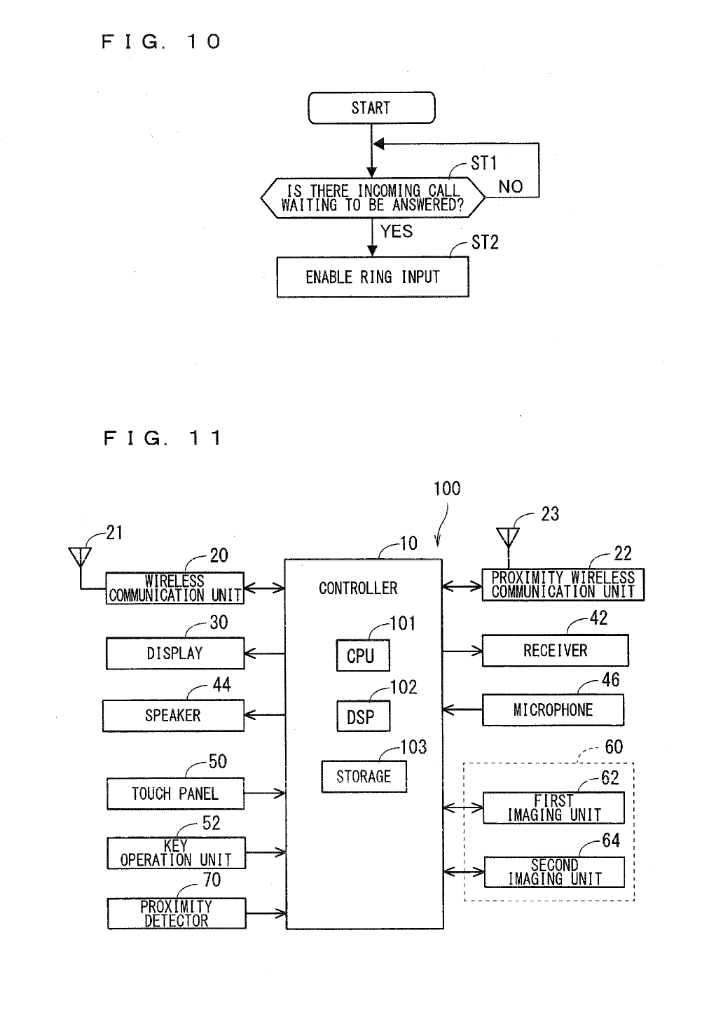

FIGS. 7 to 9 schematically illustrate examples of the movement of the operator body part that correspond to the buttons 101a to 103a. In FIGS. 7 to 9, the path taken by the operator body part (a finger) is indicated by the thick line. Each of FIGS. 7 to 9 also shows the corresponding one of the buttons 101a to 103a, for easy understanding of the description. In the illustration of FIG. 7, the path is a line curved outwardly to the lower left. In response to this movement, a command to “answer” the incoming call is input to the mobile phone 100. In the illustration of FIG. 8, the path is a line curved upwardly. In response to this movement, a command to “reject” the incoming call is input to the mobile phone 100. In the illustration of FIG. 9, the path takes the shape schematically showing an envelope. In response to this movement, a command to “transmit a message” in reply to the incoming call is input to the mobile phone 100.

The controller 10 can perform processing corresponding to the input identified by the input identifying unit 121. For example, the call processor 11 answers and rejects the incoming call in response to the respective actions illustrated in FIGS. 7 and 8. The message processor 13 executes the message processing in response to the action illustrated in FIG. 9.

The setting unit 122 can activate (enable) and disactivate (disable) the input that is done by operating the wearable input apparatus 200 (hereinafter also referred to as a “ring input”). When the ring input is valid, the controller 10 executes the processing corresponding to the ring input. When the ring input is invalid, the controller 10 does not execute the processing corresponding to the ring input. For example, when the ring input is valid, the input identifying unit 121 identifies the input based on the motion information MD1, and then, outputs the identified input to the appropriate processor. When the ring input is invalid, the input identifying unit 121 does not need to identify the input. In order to disable the ring input, the transmission of the motion information MD1 from the wearable input apparatus 200 is stopped or the identified input is not output to the appropriate processor.

As will be described below in detail, the setting unit 122 enables the ring input when the call processor 11 receives an incoming call waiting to be answered.

FIG. 10 illustrates a flowchart showing an example of the action performed by the controller 10. The action shown in FIG. 10 is performed while a voice call with the first phone apparatus is ongoing. Firstly, in Step ST1, the call processor 11 determines whether there is an incoming call received from the second phone apparatus, which is different from the first phone apparatus, and waiting to be answered. When there is no incoming call waiting to be answered, Step ST1 is performed again. When determining that there is an incoming call waiting to be answered, the controller 10 provides a notification to the user, and in Step ST2, outputs the information to the setting unit 122. Upon receipt of the information, the setting unit 122 enables the ring input.

The notification to the user may be provided in the following manner. The wearable input apparatus 200 includes a notification provider (e.g., a vibration element, a light-emitting element, a display, or a sound output unit). The call processor 11 notifies the wearable input apparatus 200 of an incoming call. Then, the notification provider of the wearable input apparatus 200 notified of the incoming call provides a notification to the user. Thus, the wearable input apparatus 200 can make the user aware of the incoming call.

The ring input is valid in this state, and thus, the user can use the wearable input apparatus 200 to respond to the incoming call waiting to be answered. The user can respond to the incoming call waiting to be answered, by moving the operator body part so as to give a command to “answer the call”, “reject the call”, or “transmit a message”.

Specifically, the input identifying unit 121 identifies the input based on the motion information MD1 indicative of the movement of the operator body part, as mentioned above. When the input signifies a command to “answer the call”, the input identifying unit 121 outputs the command to the call processor 11. For example, the call processor 11 places the voice call with the first phone apparatus on hold, and then, initiates a voice call with the second phone apparatus. When the input signifies a command to “reject the call”, the input identifying unit 121 outputs the command to the call processor 11. Then, the call processor 11 rejects the call from the second phone apparatus.

When the identified input signifies a command to “transmit a message”, the input identifying unit 121 outputs the command to the call processor 11. The call processor 11 transmits the information on the address (e.g., the telephone number) of the second phone apparatus to the message processor 13. The message processor 13 waits for the user to input a message. The user moves the operator body part so as to input letters in the message one by one. The input identifying unit 121 identifies the letters one by one based on the motion information MD1, and then, outputs the identified letters to the message processor 13. The message processor 13 receives the input of the message accordingly.

Then, the user moves the operator body part so as to give a transmission command for transmitting a message to the second phone apparatus. The input identifying unit 121 identifies the received input as the transmission command based on the motion information MD1, and then, outputs the identified input to the message processor 13. The message processor 13 transmits the input message to the second phone apparatus via the wireless communication unit 20. The second phone apparatus receives the message and displays the received message. This makes the user of the second phone apparatus aware of the intention expressed by the user of the mobile phone 100 via the message.

As mentioned above, the user can operate the wearable input apparatus 200 to respond to the incoming call waiting to be answered, without directly operating the mobile phone 100, or, without operating the display area 2a. That is, the user can respond to the incoming call waiting to be answered, without taking the mobile phone 100 off the ear. The user can respond to the incoming call waiting to be answered while continuing the voice call with the calling party (the user of the first phone apparatus) without interruption.

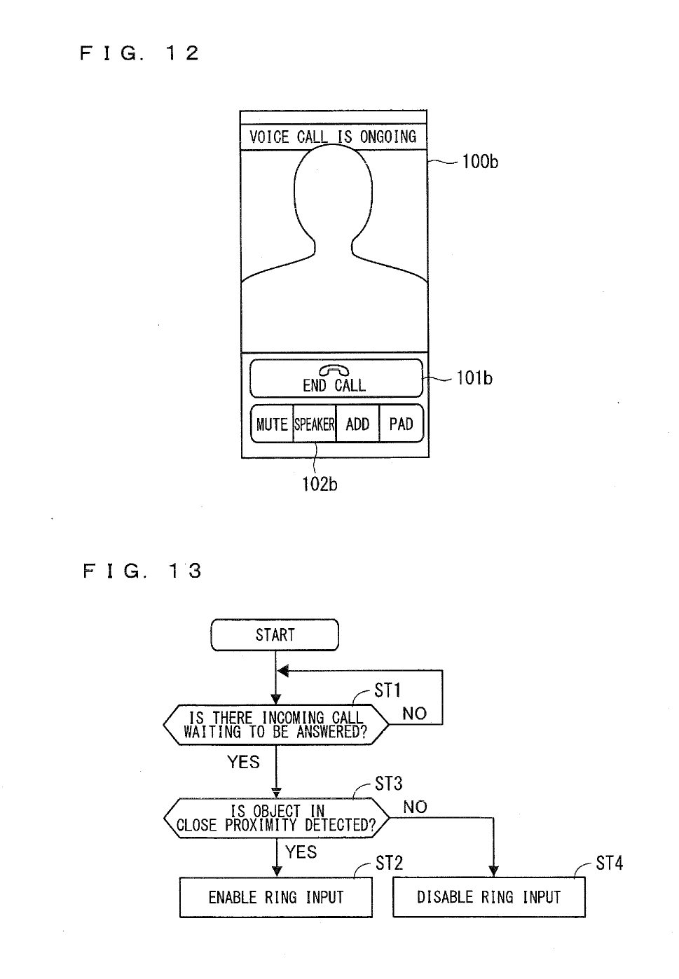

FIG. 11 illustrates a block diagram showing an example of the electrical configuration of the mobile phone 100. In the illustration of FIG. 11, the mobile phone 100 includes a proximity detector 70 in addition to the functional units shown in FIG. 4. The proximity detector 70 can detect an external object in proximity and output the detection result to the controller 10. Specifically, for example, the proximity detector 70 detects, at the very least, an object in proximity on the front surface side of the mobile phone 100. In the state in which the user is holding the mobile phone 100 close to the face to speak on the phone, the proximity detector 70 can detect the face as an object in proximity.

For example, the proximity detector 70 may emit light (e.g., invisible light) to the outside. When receiving reflected light, the proximity detector 70 detects an external object in proximity. Alternatively, the proximity detector 70 may be an illuminance sensor that can receive external light (e.g., natural light). When an external object approaches the illuminance sensor, the object blocks the light, thus lowering the intensity of light incident on the illuminance sensor. The proximity detector 70 can detect the object in proximity on the ground that the intensity of light detected by the illuminance sensor is lower than the reference value. Still alternatively, the proximity detector 70 may be, for example, the first imaging unit 62. In this case, the intensity of light incident on the imaging lens 6a is lowered as an object approaches the imaging lens 6a. The proximity detector 70 can detect the object in proximity on the ground that the average of pixel values of captured images is smaller than the reference value.

The call processor 11 can also perform a voice call through the speaker 44 of the mobile phone 100. The call processor 11 can output, through the speaker 44, a sound transmitted from the first phone apparatus, at a volume higher than the volume at which a sound is output through the receiver 42. The user can recognize the sound transmitted from the first phone apparatus while being apart from the mobile phone 100. In this state, the call processor 11 may enhance the sensitivity of the microphone 46 to receive the input of the user's voice. This helps the microphone 46 to convert the sound uttered by the user apart from the mobile phone 100 into a sound signal appropriately.

The user can make a selection between a voice call through the receiver 42 (hereinafter referred to as a “normal call”) and a voice call through the speaker 44 (hereinafter referred to as a “speaker call”). For example, the call processor 11 displays a button for use in switching between these calls on an ongoing call screen. FIG. 12 schematically illustrates an example of an ongoing call screen 100b during the voice call. The ongoing call screen 100b shows a “call end” button 101b and a “speaker” button 102b. The button 101b is for use in ending a call and the button 102b is for use in initiating a speaker call involving sound output through the speaker 44. The other buttons shown in FIG. 12 will not be further elaborated here.

When the user performs an operation on the button 101b, the operation is detected by the touch panel 50, and then, the information is input to the call processor 11. The call processor 11 interrupts the communication with the first phone apparatus to end the call.

When the user performs an operation on the button 102b, the operation is detected by the touch panel 50, and then, the information is input to the call processor 11. The call processor 11 initiates a speaker call. Then, in place of the button 102b, a button for use in initiating a normal call is displayed. The user can operate this button to return to the normal call.

Thus, in response to the user's input, the call processor 11 can perform the switching between the normal call through the receiver 42 and the speaker call through the speaker 44.

It is not always required that the button for use in switching between these calls be displayed on the display 30. Alternatively, any one of a plurality of operation keys 5 may be assigned with the task. The same holds true for the other buttons, which will be described below. Although the normal call through the receiver 42 has been described above, the receiver 42 may be replaced with a piezoelectric vibration element, as mentioned above. The same holds true for other embodiments, which will be described below.

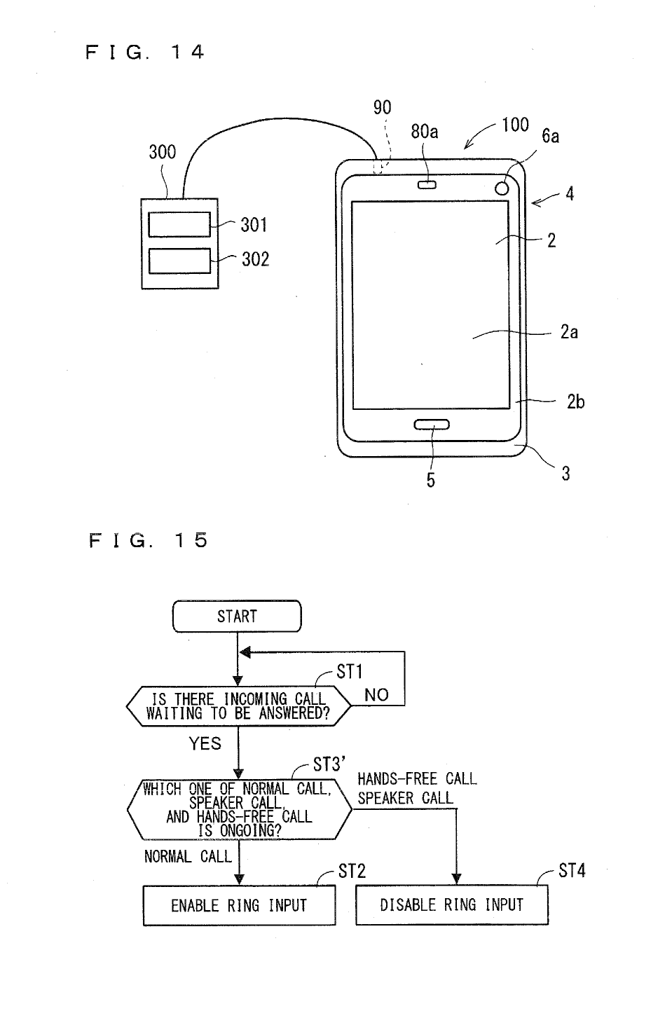

When the proximity detector 70 detects an object in proximity and there is an incoming call waiting to be answered, the setting unit 122 enables the ring input. This action will be specifically described below with reference to FIG. 13. FIG. 13 illustrates a flowchart showing an example of the action performed by the controller 10. In addition to the steps of FIG. 10, Steps ST3 and ST4 are performed. For example, when it is determined in Step ST1 that there is an incoming call waiting to be answered, Step ST3 is performed. In Step ST3, the setting unit 122 determines whether the proximity detector 70 detects an object in proximity. When it is determined that an object in proximity is detected, the setting unit 122 enables the ring input in Step ST2.

When it is determined in Step ST3 that no object in proximity is detected, the setting unit 122 disables the ring input in Step ST4.

When there is an incoming call waiting to be answered in the state in which the user is holding the mobile phone 100 close to the face to speak on the phone, the proximity detector 70 detects the face as an object in proximity, and thus, the ring input is enabled in accordance with the above-mentioned action. The user can use the wearable input apparatus 200 to input, to the mobile phone 100, a response to the incoming call waiting to be answered.

When the proximity detector 70 detects no object in proximity, that is, when the user is apart from the mobile phone 100, the ring input is disabled. For example, during the speaker call, the user has a phone conversation at some distance from the mobile phone 100. The call processor 11 displays the incoming call screen 100a shown in FIG. 12, thereby prompting the user to respond to the incoming call waiting to be answered. The user can directly operate the display area 2a of the mobile phone 100 to respond to the incoming call waiting to be answered.

Disabling the ring input offers, for example, the following advantage. In some cases, when directly operating the mobile phone 100, the user accidentally moves the operator body part in such a manner as to perform a certain input. However, the input relevant to the action does not take effect on the mobile phone 100, and thus, does not interfere with the user's direct operation on the mobile phone 100. This can enhance the operability.

In the state in which an object in proximity is detected, the call processor 11 may disable the functions of, for example, the buttons 101b and 102b on the ongoing call screen 100b. For example, the call processor 11 may cause the display 30 to stop performing display. The user can avoid operating the buttons 101b and 102b in error while keeping the face in contact with the display area 2a.

As distinct from the example above, the ring input may be enabled when the proximity detector 70 detects no object.

Once the ring input is disabled, the wearable input apparatus 200 does not need to provide a notification through the use of call waiting. The user thus becomes aware that the ring input is invalid.

An example of the electrical configuration of the mobile phone 100 here may be as in FIG. 4 or FIG. 11.

Voice Call Through Hands-Free Apparatus 300

FIG. 14 illustrates a diagram for describing a call mode that employs a hands-free apparatus 300, which is external to the mobile phone 100. The hands-free apparatus 300 is wired to the mobile phone 100. Specifically, the mobile phone 100 includes a connector 90, and the hands-free apparatus 300 has a wired connection with the mobile phone 100 through a code connected to the connector 90. Inside the mobile phone 100, the connector 90 is connected with the controller 10.

The call processor 11 outputs, for example, a sound signal received from the first phone apparatus, to the hands-free apparatus 300 via the connector 90. The hands-free apparatus 300 includes a speaker 301. The sound corresponding to the sound signal is output through the speaker 301. The speaker 301 is, for example, an earphone and may be mounted to the hands-free apparatus 300. Alternatively, the hands-free apparatus 300 may be a tabletop apparatus, and the speaker 301 may be embedded in the hands-free apparatus 300.

The user's voice may be input to, for example, the microphone 46 of the mobile phone 100. Alternatively, the hands-free apparatus 300 may include a microphone 302. The microphone 302 can convert the sound uttered by the user into a sound signal, and then, the hands-free apparatus 300 outputs the sound signal to the mobile phone 100. The call processor 11 receives, via the connector 90, the sound signal transmitted from the hands-free apparatus 300, and then, transmits the sound signal to the first phone apparatus via the wireless communication unit 20.

This configuration enables the user to have a phone conversation through the hands-free apparatus 300 (hereinafter referred to as a “hands-free call”). In this case, the user does not need to hold the mobile phone 100 close to the face during the voice call.

The call processor 11 can perform one of the above-mentioned calls that is selected by the user. Alternatively, upon receipt of an incoming call, the call processor 11 may determine whether the hands-free apparatus 300 is connected with the mobile phone 100. When the user operates the button 101a in the state in which the hands-free apparatus 300 is connected with the mobile phone 100, the call processor 11 may perform a voice call through the hands-free apparatus 300. That is, when the hands-free apparatus 300 is connected with the mobile phone 100, the hands-free call may be prioritized.

Still alternatively, the user may perform an input to the mobile phone 100 in order to make a selection from the above-mentioned types of calls. For example, the call processor 11 may display a button for use in making a selection, and thus, the user can operate the button to make a selection from the above-mentioned types of calls. One of the operation keys 5 may be assigned with the task of this button. The same holds true for the other buttons.

The hands-free apparatus 300 may include, for example, an input unit for use in inputting a command to “answer” or “reject” an incoming call. In this case, the user responds to the incoming call by operating the input unit, and then, the information is input to the call processor 11. The call processor 11 may initiate a hands-free call accordingly. That is, when the hands-free apparatus 300 is used to respond to the incoming call, the call processor 11 may prioritize the hands-free call.

The hands-free apparatus 300 may include a notification provider. In this case, the call processor 11 may notify the hands-free apparatus 300 of an incoming call, and then, the notification provider of the hands-free apparatus 300 may provide a notification to the user.

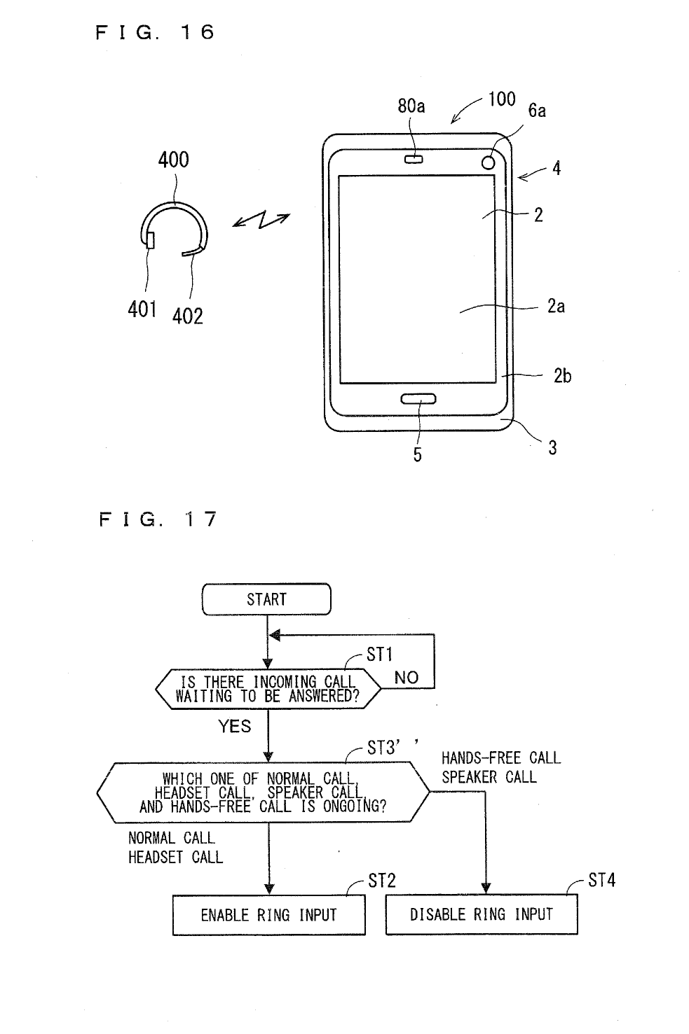

FIG. 15 illustrates a flowchart showing an example of the action performed by the controller 10. In place of ST3 of FIG. 13, Step ST3′ is performed. In Step ST3′, the call processor 11 determines which one of the normal call, the speaker call, and the hands-free call is ongoing. The determination result is output to the setting unit 122. To make such a determination, the call processor 11 stores, for example, the relevant call mode when initiating a call.

For the normal call, the setting unit 122 enables the ring input in Step ST2. As in the one embodiment, the user can use the wearable input apparatus 200 to respond to an incoming call received from the second phone apparatus and waiting to be answered, without taking the mobile phone 100 off the ear.

For the speaker call or the hands-free call, the setting unit 122 disables the ring input in Step ST4. As in one embodiment, this can avoid operation errors caused by the ring input, thus enhancing the operability.

FIG. 16 illustrates a diagram for describing a voice call though a headset apparatus 400 (hereinafter referred to as a “headset call”). The mobile phone 100 is wirelessly connected to the headset apparatus 400, which is external to the mobile phone 100. The headset apparatus 400 includes a wireless communication unit (e.g., a proximity wireless communication unit), a speaker 401, and a microphone 402, and is to be worn by the user.

The headset apparatus 400 can communicate with the mobile phone 100 via the proximity wireless communication unit. For example, the headset apparatus 400 can receive a sound signal from the mobile phone 100, and then, output the sound corresponding to the sound signal through the speaker 401. The speaker 401 is, for example, an earphone and mounted to the headset apparatus 400. The microphone 402 of the headset apparatus 400 can convert the sound uttered by the user into a sound signal. The headset apparatus 400 outputs the sound signal to the mobile phone 100 via the proximity wireless communication unit. This configuration enables the user to have a phone conversation through the headset apparatus 400.

Unlike wired communication, the headset communication, in which the headset apparatus 400 and the mobile phone 100 perform wireless communication with each other, permits free use of the space between the headset apparatus 400 and the mobile phone 100.

The headset apparatus 400 may include an input unit for use in imputing a response to an incoming call. The user inputs a response to an incoming call to the input unit of the headset apparatus 400, and then, the headset apparatus 400 transmits the input to the mobile phone 100. The call processor 11 executes processing (e.g., answer or rejection) corresponding to the input.

The headset apparatus 400 may also include a notification provider. In this case, the call processor 11 may notify the headset apparatus 400 of an incoming call, and then, the notification provider of the headset apparatus 400 may provide a notification to the user.

The selection from the above-mentioned types of calls can be made by, for example, the user's input. For example, the call processor 11 causes the display 30 to display a button for use in determining which type of call is to be performed. The user can operate the button to determine which type of call is to be performed. Alternatively, when the transmission and reception of signals via the headset apparatus 400 are permitted, the call processor 11 may opt for the headset apparatus 400. When the user operates the input unit of the headset apparatus 400 to respond to an incoming call, the call processor 11 may perform a headset call. When the user operates the button 101a displayed on the mobile phone 100 to respond to an incoming call, the call processor 11 may perform a normal call.

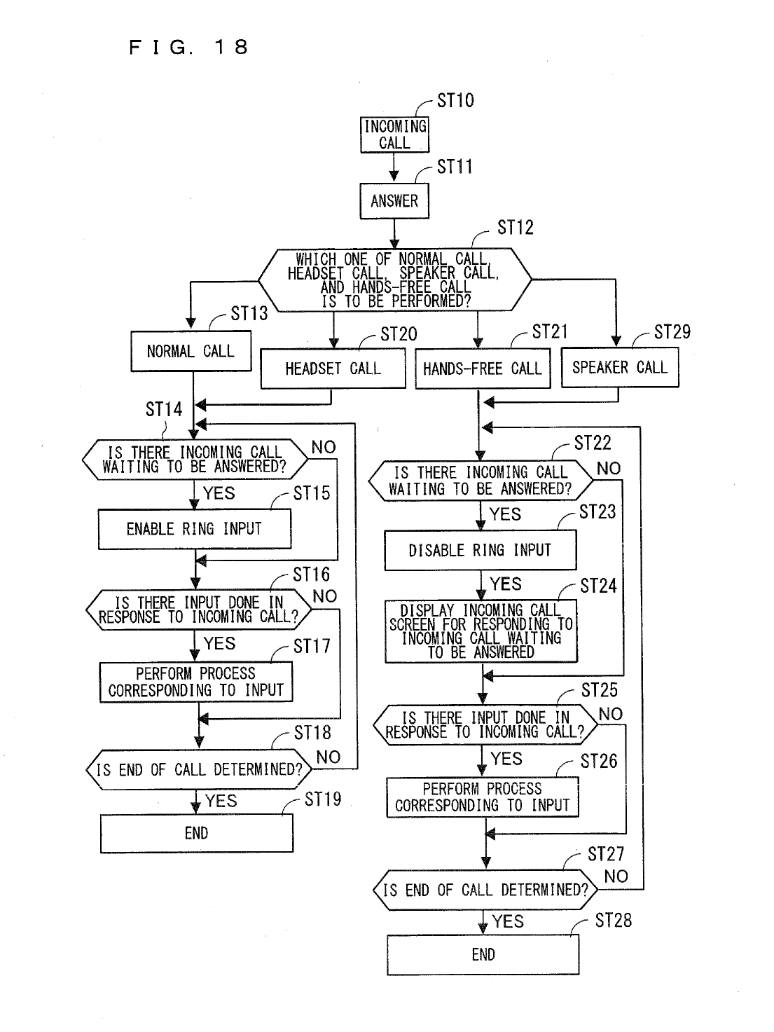

FIG. 17 illustrates a flowchart showing an example of the action performed by the controller 10. In place of Step ST3 of FIG. 13, Step ST3″ is performed. In Step ST3″, the call processor 11 determines which one of the normal call, the headset call, the speaker call, and the hands-free call is ongoing. The determination result is output to the setting unit 122.

For the normal call and the headset call, the setting unit 122 enables the ring input in Step ST2. As in one embodiment, the user can respond to an incoming call waiting to be answered, without taking the mobile phone 100 off the ear. For the headset call through the headset apparatus 400, the user assumedly conducts other work during a call. For example, the user speaks on the phone while operating a vehicle. In such a case, it is difficult for the user to directly operate the mobile phone 100. Instead, the user can operate the wearable input apparatus 200 since the ring input is valid.

For the speaker call and the hands-free call, the setting unit 122 disables the ring input in Step ST4 as in one embodiment. As in one embodiment, this can avoid operation errors caused by the ring input, thus enhancing the operability.

The hands-free apparatus 300 and the headset apparatus 400 have been distinguished by being wired or wireless, respectively. Alternatively, the hands-free apparatus 300 and the headset apparatus 400 may be distinguished by being a tabletop apparatus or a wearable apparatus, respectively. In this case, the hands-free apparatus 300 may be a tabletop apparatus and the headset apparatus 400 may be a wearable apparatus. In many cases, the tabletop hands-free apparatus 300 is installed in a room or the like. The user mainly uses the wearable headset apparatus 400 to speak on the phone while doing something else (e.g., operating a vehicle or running) and thus being unable to readily perform an operation directly on the mobile phone 100. The controller 10 here offers an advantage in that the ring input is valid during a voice call through the wearable headset apparatus 400.

Switching among the above-mentioned types of calls may be allowed during a voice call. In this case as well, the ring input may be enabled as mentioned above, depending on which type of call is ongoing when there is an incoming call waiting to be answered.

FIG. 18 illustrates an example of the action performed by the controller 10. FIG. 18 illustrates an example flowchart summarizing the above-mentioned action. In Step ST10, the call processor 11 receives an incoming call signal. In Step ST11, the user performs an operation to answer the incoming call. In Step ST12, the call processor 11 determines which one of the normal call, the headset call, the speaker call, and the hands-free call is to be performed.

When determining in Step ST12 that the normal call is to be performed, the call processor 11 initiates the normal call in Step ST13. The normal call is continued until the end of voice call, which will be described below.

Then, in Step ST14, the call processor 11 determines whether there is an incoming call received from the second phone apparatus and waiting to be answered. When it is determined that there is an incoming call waiting to be answered, the setting unit 122 enables the ring input in Step ST15. Then, in Step ST16, the call processor 11 waits for the user to respond to the incoming call waiting to be answered. Specifically, the state of waiting for the user's response continues while the incoming call is waiting to be answered. In Step ST16, the user inputs a response to the incoming call waiting to be answered. Then, in Step ST17, the call processor 11 executes the processing corresponding to the input. For example, when a command to “answer” the incoming call is input in Step ST16, the voice call with the first phone apparatus is placed on hold and a voice call with the second phone apparatus is initiated in Step ST17. When a command to “reject” the incoming call is input in Step ST16, the call from the second phone apparatus is rejected in Step ST17. When a command to “transmit a message” is input in Step ST16, the address information (telephone number) of the second phone apparatus is output to the message processor 13 in Step ST17. The message processor 13 receives the message input by the user, and then, transmits the message in response to the transmission command input by the user.

After Step ST17 or when determining in Step ST16 that no input is done in response to the incoming call waiting to be answered, the call processor 11 determines in Step ST18 whether to end the ongoing voice call. For example, the call processor 11 determines the end of voice call when the user selects the button 101b displayed on the mobile phone 100. Alternatively, the call processor 11 may determine the end of voice call when receiving the information indicating that the calling party has ended the call. If the end of voice call is not determined, Step ST14 is performed again. If the end of voice call is determined, the ongoing voice call is ended in Step ST19.

When determining in Step ST12 that the headset call is to be performed, the call processor 11 initiates the headset call in Step ST20. The headset call is continued until the end of voice call in Step ST19. Subsequently to Step ST20, Steps ST14 to ST19 are performed.

When determining in Step ST12 that the hands-free call is to be performed, the call processor 11 initiates the hands-free call in Step ST21. The hands-fee call is continued until the end of voice call in the downstream step.

In Step ST22, the call processor 11 determines whether there is an incoming call received from the second phone apparatus and waiting to be answered. When it is determined that there is an incoming call waiting to be answered, the setting unit 122 disables the ring input in Step ST23. Then, in Step ST24, the call processor 11 causes the display 30 to display the incoming call screen 100a (see FIG. 6) for prompting the user to respond to the incoming call waiting to be answered. In Step ST25, the call processor 11 determines whether the user performs an input in response to the incoming call waiting to be answered. When the user performs an input in response to the incoming call waiting to be answered, the call processor 11 performs the processing corresponding to the input in Step ST26.

After Step ST26 or when determining in Step ST25 that no input is done, the call processor 11 determines in Step ST27 whether to end the ongoing voice call. For example, the end of voice call is determined when the user selects the call end button. Alternatively, the end of voice call may be determined when the calling party has ended the call. If the end of voice call is not determined, Step ST22 is performed again. If the end of voice call is determined, the ongoing voice call is ended in Step ST28.

When determining in Step ST12 that the speaker call is to be performed, the call processor 11 initiates the speaker call in Step ST29. The speaker call is continued until the end of voice call in Step ST28. Subsequently to Step ST29, Steps ST22 to ST28 are performed.

The incoming call screen 100a in Step ST24 may also be displayed when it is determined in Step ST14 that there is an incoming call waiting to be answered. In this case, the user may use either the ring input or the incoming call screen 100a to respond to the incoming call waiting to be answered during the normal call and the headset call.

An example of the electrical configuration of the mobile phone 100 here is as in FIG. 11. FIG. 19 illustrates a flowchart showing an example of the action performed by the controller 10. In addition to the steps of FIG. 13, Step ST5 is performed as illustrated in FIG. 19.

For example, Step ST5 is performed when it is determined in Step ST3 that no object in proximity is detected. In Step ST5, the call processor 11 determines whether the headset call is ongoing. When it is determined that the headset call is ongoing, Step ST2 is performed. When it is determined that no headset call not ongoing, Step ST4 is performed.

For the normal call, the user holds the mobile phone 100 close to the face to speak on the phone, and thus, the proximity detector 70 detects the face as an object in proximity (Step ST3). The ring input is accordingly enabled for the normal call (Step ST2). Similarly, the ring input is enabled (Step ST2) for the headset call (Step ST 5).

For the speaker call and the hands-free call, meanwhile, the proximity detector 70 detects no object in proximity (Step ST3) and it is determined that no headset call is ongoing (Step ST5), and thus, the ring input is disabled (Step ST4).

The above-mentioned action can be performed as in one embodiment. In addition, through the use of the proximity detector 70, the state in which the user is holding the mobile phone 100 close to the face can be detected more reliably. That is, the ring input is enabled when the state in which the user is unable to readily perform an operation directly on mobile phone 100, or, the state in which the necessity to do the ring input is great is detected with a high degree of reliability.

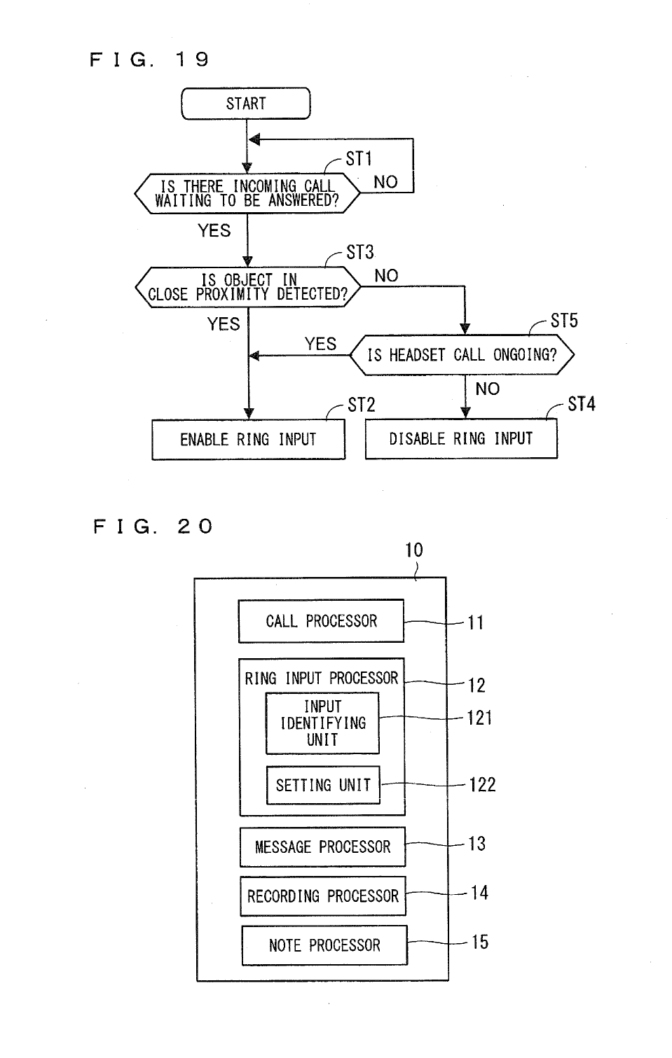

FIG. 20 illustrates an example configuration of the controller 10. The controller 10 here includes a recording processor 14 and a note processor 15 in addition to the functional units shown in FIG. 5. The recording processor 14 is the functional unit that can record a phone conversation and can store, in chronological order, a sound signal indicative of the sound uttered by the user and a sound signal transmitted from the calling party. The recording processor 14 can play back the recorded data that has been stored. The user can instruct the mobile phone 100 to, for example, start recording, stop recording, playing back the recorded data, and stop playing back the recorded data. The recording processor 14 can perform the processing corresponding to the instruction. For example, the controller 10 displays, on the display area 2a, various buttons corresponding to inputs. The user can operate these buttons to perform inputs to the mobile phone 100 that are relevant to recording. In the case where the ring input is enabled, the user can operate the wearable input apparatus 200 to perform such an input.

The note processor 15 is the functional unit that can create data on text and/or graphics (hereinafter also referred to as “note data”) and store the created data. The note processor 15 causes the display 30 to display the stored note data. The user can instruct the mobile phone 100 to, for example, input text, input graphics, store text or graphics (in a storage), display the note data, and stop displaying the note data. The note processor 15 can perform the processing corresponding to the instruction. For example, the controller 10 displays various buttons corresponding to inputs on the display area 2a. The user can operate these buttons to perform inputs to the mobile phone 100 that are relevant to notes. In the case where the ring input is enabled, the user can operate the wearable input apparatus 200 to perform such an input.

The above-mentioned action of the call processor 11 for an incoming call waiting to be answered may take priority over the actions of the recording processor 14 and the note processor 15. That is, when there is an incoming call waiting to be answered, the actions of the recording processor 14 and the note processor 15 may be halted to permit the call processor 11 to perform the action for the incoming call waiting to be answered.

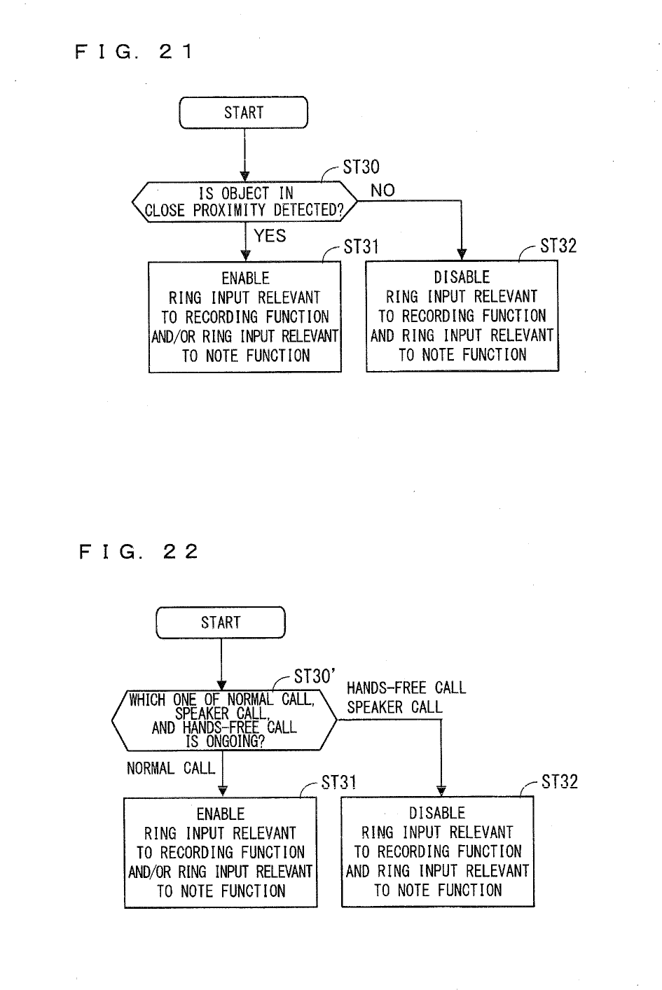

When the call processor 11 performs a voice call and the proximity detector 70 detects an object in proximity, the setting unit 122 enables the ring input. FIG. 21 illustrates a flowchart showing an example of the action performed by the controller 10. This flowchart is implemented during a voice call. This flowchart may be implemented only once at the start of the voice call or may be implemented for several iterations.

In Step ST30, it is detected whether the proximity detector 70 detects an object in proximity. When the proximity detector 70 detects an object in proximity, in Step ST31, the setting unit 122 enables the ring input to the recording processor 14 and/or the ring input to the note processor 15.

The following will describe the case in which the ring input to the recording processor 14 is enabled. For example, the user moves the operator body part so as to give a command to “start recording”. The input identifying unit 121 identifies the movement based on the motion information MD1, and then, outputs the information to the recording processor 14. The recording processor 14 starts recording a phone conversation. That is, the recording processor 14 stores, in chronological order, a sound signal indicative of the sound uttered by the user and a sound signal transmitted from the calling party, in a storage (e.g., the storage 103). When the user moves the operator body part so as to give a command to “stop recording”, or, when the call is ended, the recording processor 14 stops recording the phone conversation.

The same holds true for the case in which the ring input to the note processor 15 is enabled. For example, the user moves the operator body part so as to give a command to “input text information”. The input identifying unit 121 identifies the movement based on the motion information MD1, and then, outputs the information to the note processor 15. Subsequently, the user moves the operator body part so as to input, for example, letters in the text information one by one. The input identifying unit 121 identifies the letters and output the identified letters to the note processor 15 one by one. When the user moves the operator body part so as to give a command to “store”, the note processor 15 stores the input text information in a storage (e.g., the storage 103).

Once the user moves the operator body part so as to give a command to “input graphics”, the note processor 15 recognizes the path subsequently taken by the operator body part as graphics. When the user moves the operator body part so as to give a command to “store”, the note processor 15 stores the graphics in a storage (e.g., the storage 103).

When the proximity detector 70 detects no object in proximity in Step ST30, the setting unit 122 disables the ring input. For example, the setting unit 122 disables the ring input to the recording processor 14 and the ring input to the note processor 15.

In this case, the user operates the display area 2a of the mobile phone 100 to perform inputs to the mobile phone 100 (e.g., an input to the recording processor 14 and an input to the note processor 15).

As mentioned above, in the case where an object in proximity is detected during a voice call, the ring input is enabled. This means that the ring input is enabled in the state in which the user is unable to readily perform an operation directly on the mobile phone 100. In other words, the ring input may be enabled in the state in which the necessity to do the ring input is great.

FIG. 22 illustrates a flowchart showing an example of the action performed by the controller 10. In place of Step ST30 of FIG. 21, Step ST30′ is performed. In Step ST30′, the call processor 11 determines which one of the normal call, the speaker call, and the hands-free call is ongoing. The determination result is output to the setting unit 122. When it is determined in Step ST30′ that the normal call is ongoing, Step ST31 is performed. When it is determined in Step ST30′ that the speaker call or the hands-free call is ongoing, Step ST32 is performed.

For the normal call, the ring input is enabled. The ring input is enabled in the state in which the user is unable to readily perform an operation directly on the mobile phone 100, or, in the state in which the necessity to do the ring input is great.

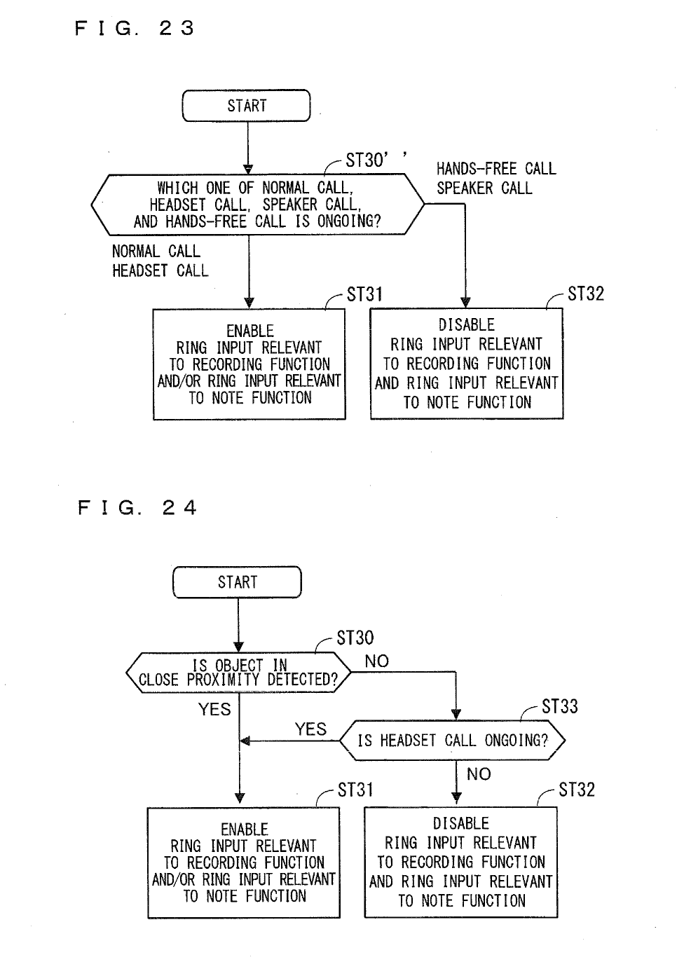

FIG. 23 illustrates a flowchart showing an example of the action performed by the controller 10. In place of Step ST30 of FIG. 21, Step ST30″ is performed. In Step ST30″, the call processor 11 determines which one of the normal call, the headset call, the speaker call, and the hands-free call is ongoing. The determination result is output to the setting unit 122. When it is determined in Step ST30′ that the normal call or the headset call is ongoing, Step ST31 is performed. When it is determined in Step ST30′ that the speaker call or the hands-free call is ongoing, Step ST32 is performed.

For the normal call and the headset call, the ring input is enabled. This means that the ring input is enabled in the state in which the user is unable to readily perform an operation directly on the mobile phone 100.

FIG. 24 illustrates a flowchart showing an example of the action performed by the controller 10. In addition to the steps of FIG. 21, Step ST33 is performed. For example, Step ST33 is performed when it is determined in Step ST30 that no object in proximity is detected. In step ST33, the call processor 11 determines whether the headset call is ongoing. When it is determined that the headset call is ongoing, Step ST2 is performed. When it is determined that no headset call is ongoing, Step ST4 is performed.

The above-mentioned action can be performed as in FIG. 23. In addition, through the use of the proximity detector 70, the state in which the user is holding the mobile phone 100 close to the face can be detected more reliably. That is, the ring input is enabled when the state in which the user is unable to readily perform an operation directly on the mobile phone 100, or, the state in which the necessity to do the ring input is great is detected with a high degree of reliability.

The ring input may be directed at any other processor that can perform processing corresponding to the ring input, instead of the recording processor 14 and the note processor 15.

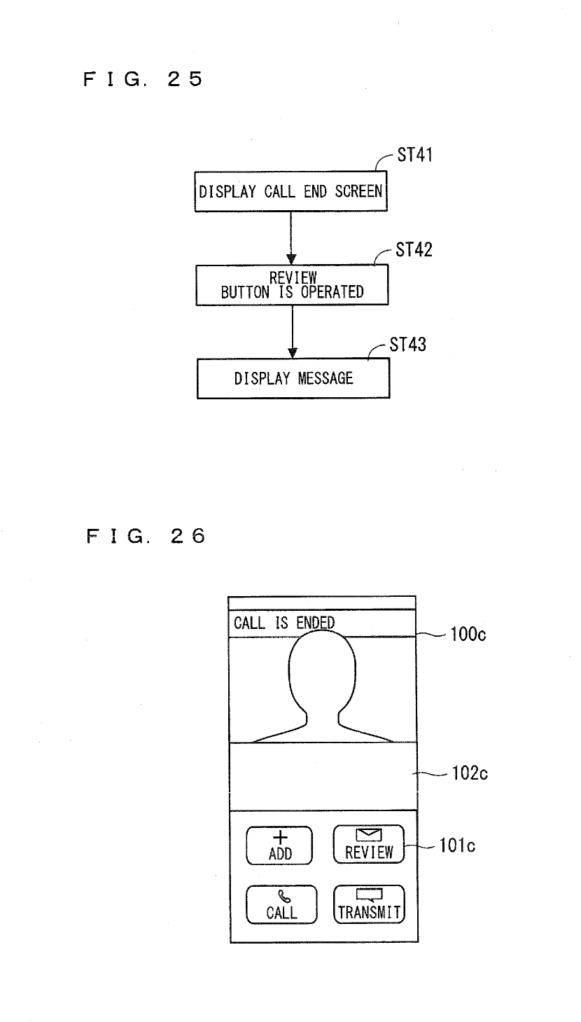

In one embodiment, the following will describe the action performed by the call processor 11 after the user ends the voice call. FIG. 25 illustrates an example flowchart subsequent to the end of voice call. In Step ST41, the call processor 11 causes the display 30 to display a call end screen. FIG. 26 schematically illustrates an example of a call end screen 100c. The call end screen 100c shows, for example, a “review” button 101e. When the voice call is ended, the call processor 11 causes the display 30 to display the button 101c. The other buttons shown in FIG. 26 will not be further elaborated here.

The “review” button 101c is for use in displaying a message transmitted during a voice call. The button 101c may be displayed only in the case where a message was transmitted during a voice call. For example, the call processor 11 keeps a record of message transmission made by the user, in a storage (e.g., the storage 103). When the call is ended, the presence or absence of a record of message transmission is determined. If a record of message transmission is found, the button 101e is displayed. If no record of message transmission is found, it is not necessary to display the button 101c.

When the user performs an operation the button 101c in Step ST42, the operation is detected by the touch panel 50, and then, the information is input to the call processor 11. In Step ST43, the call processor 11 displays the message transmitted during the call on, for example, a message window 102c in the call end screen 100c, or displays another display screen and displays the message on the display screen. In addition, the call processor 11 may display the address information together with the message.

The user can review the transmitted message accordingly. In the case where the user transmits a message through the wearable input apparatus 200 during the normal call, the user is unable to readily view the transmitted message in the middle of the call. Once the above-mentioned action is performed, the button 101c appears on the call end screen 100c at the end of voice call, so that the user can readily review the message. This can enhance the convenience.

Alternatively, the “review” button 101c may not be displayed at the end of voice call, and the call processor 11 may cause the display 30 to display the message alone or together with the address information, without the user having to perform an input. The user can thus review the message more easily.

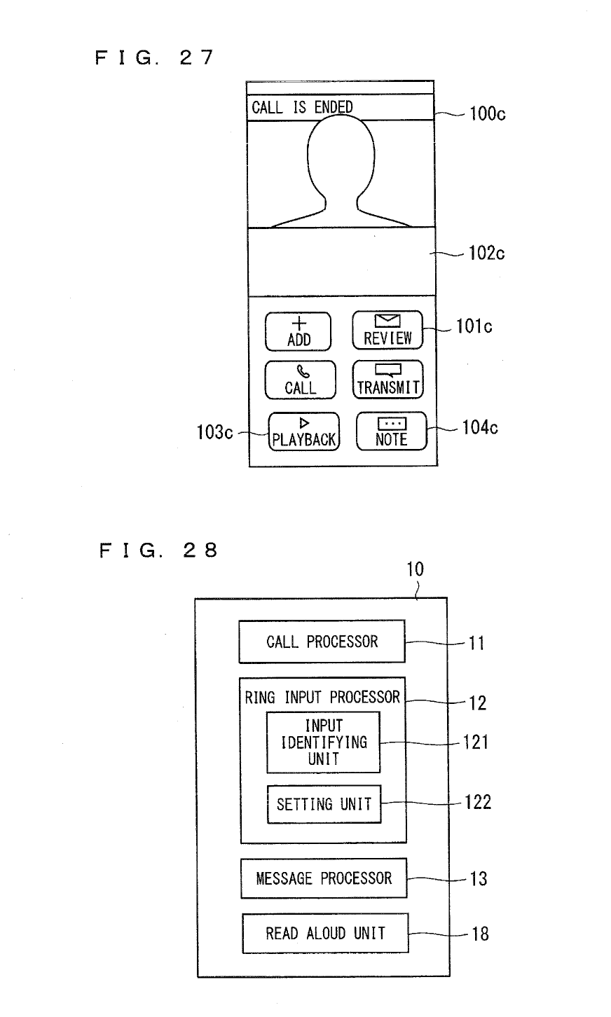

In one embodiment, the wearable input apparatus 200 has been used to record a phone conversation and store a note. The call end screen may show a button for use in playing back the recorded data or a button for reviewing note data. FIG. 27 schematically illustrates an example of the call end screen 100c. In the illustration of FIG. 27, a “playback” button 103c and a “note” button 104c are shown.

When the user performs an operation on the button 103c, the operation is detected by the touch panel 50, and then, the information is input to the recording processor 14. The recording processor 14 plays back sound data recorded during a voice call. The sound data may be output to the receiver 42 or the speaker 44. Alternatively, the sound data may be output to the speaker of the hands-free apparatus 300 or the speaker of the headset apparatus 400.

The button 103c is shown on the call end screen 100c, Thus, when ending a voice call, the user can readily play back the data recorded during the voice call.

When the user selects the button 104c, the note processor 15 causes the display 30 to display the note data created during a voice call. The button 104c is shown on the call end screen 100c. Thus, when ending the voice call, the user can readily review the note data created during the voice call.

The recorded data may be played back and the note data may be displayed, without the user having to operate a button. That is, when the voice call is ended, these functions may be performed, without the user having to perform an input.

FIG. 28 schematically illustrates an example of the internal configuration of the controller 10. The controller 10 here includes a read aloud unit 18 in addition to the functional units shown in FIG. 5.

The read aloud unit 18 can, for example, analyze data on a string, create sound data (synthetic voice) indicating the pronunciation of the string, and then, output the sound data to either the receiver 42 or the speaker 44. The receiver 42 or the speaker 44 converts the sound data into a sound and outputs the sound. The synthetic voice may be output through the speaker of the hands-free apparatus 300 or the speaker of the headset apparatus 400.

For example, when there is an incoming call received from the second phone apparatus and waiting to be answered, the call processor 11 extracts the phone number of the second phone apparatus from the incoming call, and then, identifies the name of the calling party based on phone directory data, which is registered in a storage (e.g., the storage 103) in advance. The phone directory data contains phone numbers of external phone apparatuses and the names of the users of the respective apparatuses. The call processor 11 outputs the identified name to the read aloud unit 18. The read aloud unit 18 can output the name by synthetic voice. The user can thus identify the originator of the incoming call waiting to be answered, without placing the ongoing voice call on hold.

When the user inputs the text information through the wearable input apparatus 200, the text information is input to the read aloud unit 18. The read aloud unit 18 can output the text information by synthetic voice. The user can check whether the text information has been input properly, without placing the ongoing voice call on hold.

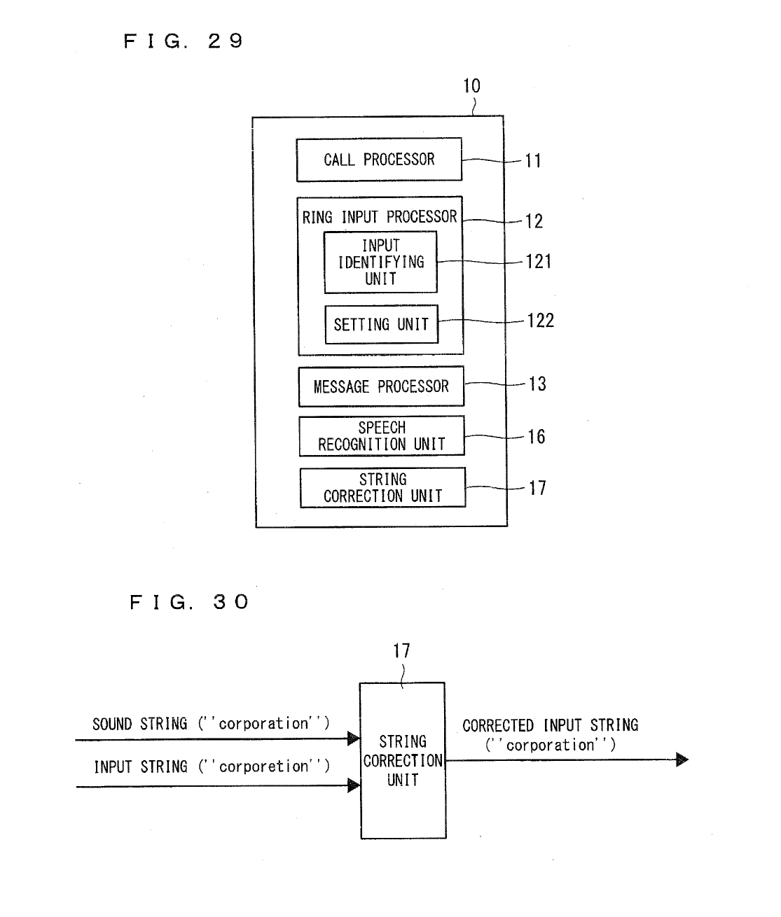

FIG. 29 illustrates an example configuration of the controller 10. The controller 10 here includes a speech recognition unit 16 and a string correction unit 17 in addition to the constituent components shown in FIG. 5. The speech recognition unit 16 can recognize a phone conversation based on a sound signal indicative of the sound uttered by the user during a voice call and a sound signal indicative of the sound uttered by the calling party during the voice call. Specifically, the speech recognition unit 16 can recognize a speech indicated by the sound signals such as words or sentences (collectively referred to as a “speech” hereinafter). Although any speech recognition method may be employed, a sound signal is compared with data on characteristics of voice prestored in a storage (e.g., the storage 103), and the speech indicated by the sound signal is identified accordingly. The data on characteristics refers to an acoustic model. The acoustic model contains data on the frequency response of sounds that are collected in different environments and from different voices and are indicative of letters. A language model may be additionally employed. The language model refers to data indicating the probability of word sequences. For example, the data indicates that there is a greater likelihood of the word “look” being followed by “at”, “for”, or “to”. This can improve the accuracy of speech recognition.

The string correction unit 17 can correct the string input through the use of the wearable input apparatus 200, based on the string recognized by the speech recognition unit 16. For example, the string correction unit 17 can organize the strings contained in a phone conversation into words. Each of the words is hereinafter also referred to as a sound string. The string correction unit 17 can, for example, calculate the degree of similarity between the sound string and a string contained in the text data input through the use of the wearable input apparatus 200 (hereinafter also referred to as an “input string”). The degree of similarity can be calculated based on, for example, the Levenshtein distance.

When the degree of similarity is greater than a predetermined value, the input string is replaced with the sound string. FIG. 30 illustrates an example of the input and output done by the string correction unit 17. Assume that the past or ongoing phone conversation contains the string “corporation” and that “corporation” is registered as the sound string. When the input string “corporetion” is input through the use of the wearable input apparatus 200, it is determined that the degree of similarity between the input string “corporetion” and the sound string “corporation” is greater than the predetermined value, and then, the string correction unit 17 makes a correction by replacing “corporetion” with “corporation” accordingly.

The string correction unit 17 outputs the corrected string to the appropriate processor (e.g., the message processor 13).

A string uttered a predetermined number of times or more in a phone conversation may be designated as the sound string that replaces the input string. Alternatively, as to a past phone conversation, a string uttered the predetermined number of times or more in the past phone conversation may be designated as the sound string. As to an ongoing phone conversation, a string may be designated as the sound string, irrespective of the number of iterations in the ongoing phone conversation. A word uttered in the ongoing phone conversation is more likely to be used in a message created during the ongoing phone conversation than a word uttered in the past phone conversation.

As a general rule, the threshold value of the number of iterations of a string designated as the sound string that replaces the input string is smaller in an ongoing phone conversation than in a past phone conversation. In other words, the string correction unit 17 designates, as the sound string, a string uttered a first number of times in the past phone conversation. Also, the string correction unit 17 designates, as the sound string, a string uttered a second number of times in the phone conversation that is ongoing when text is input though the use of the wearable input apparatus 200. The second number of times is less than the first number of times.

The foregoing description is in all aspects illustrative and not restrictive. It is understood that numerous modifications which have not been exemplified can be devised without departing from the scope of embodiments. For example, the input identifying unit 121 may be included in the wearable input apparatus 200. In this case, the input corresponding to the movement of the operator body part may be transmitted from the wearable input apparatus 200 to the mobile phone 100.

Embodiments are applicable in combination as long as they are consistent with each other. The flowcharts relevant to the individual element in the above-mentioned embodiments may be combined as appropriate. For example, all or some of FIGS. 13, 15, 17, and 19 to 25 may be combined with FIG. 18 as appropriate.

What is claimed is:

1. A mobile phone comprising:
a wireless communicator configured to receive information from an input apparatus external to the mobile phone;
a proximity detector configured to detect an object in proximity thereof; and
at least one processor configured to
perform a voice call with a first phone apparatus external to the mobile phone, and
activate an input from the input apparatus in response to detection of the object when the at least one processor performs the voice call.

2. The mobile phone according to claim 1, further comprising:
a first sound output unit configured to output a sound toward a user; and
a second sound output unit configured to output a sound at a volume higher than a volume at which the first sound output unit outputs a sound,
wherein
the at least one processor performs a voice call through the first sound output unit or the second sound output unit, and
when performing a voice call through the first sound output unit, the at least one processor activates an input from the input apparatus.

3. The mobile phone according to claim 1, wherein
the wireless communicator is capable of communicating wirelessly with an external device including a speaker, and
when a voice call is performed through the external device, the at least one processor
transmits a sound signal received from the first phone apparatus, to the external device via the wireless communicator, and causes the external device to output a sound through the speaker, and
activates an input from the input apparatus.

4. The mobile phone according to claim 1,
wherein when no object in proximity is detected, the at least one processor disactivates an input from the input apparatus.

5. The mobile phone according to claim 1, further comprising
a connector wired to a second external device including a speaker,
wherein when a voice call is performed through the second external device, the at least one processor
outputs a sound signal received from the first phone apparatus, to the second external device via the connector, and causes the second external device to output a sound through the speaker, and
disactivates an input from the input apparatus.

6. The mobile phone according to claim 1, wherein
when performing a voice call with the first phone apparatus, the at least one processor receives, from a second phone apparatus, an incoming call waiting to be answered, and
when the proximity detector detects the object in proximity and the at least one processor receives the incoming call waiting to be answered, the at least one processor activates an input done by operating the input apparatus in response to the incoming call waiting to be answered.

7. The mobile phone according to claim 6,
wherein the input done by operating the input apparatus includes a rejection of the incoming call waiting to be answered.

8. The mobile phone according to claim 1, further comprising
a display,
wherein
the at least one processor transmits a message to the outside,
when an input done by operating the input apparatus during the voice call is valid, the at least one processor transmits the message in response to the input, and
when the voice call is ended, the at least one processor causes the display to display the message transmitted during the voice call.

9. The mobile phone according to claim 1, wherein
the at least one processor records a phone conversation,
the at least one processor creates and stores text data and/or graphic data, and
when the proximity detector detects the object in proximity and the at least one processor performs the voice call, the at least one processor activates inputs done by operating the input apparatus to record the phone conversation and to create the text data and/or the graphic data.

10. The mobile phone according to claim 1,
wherein the at least one processor reads aloud a name of a user of a second phone apparatus that has originated an incoming call waiting to be answered during the voice call with the first phone apparatus.

11. The mobile phone according to claim 1, wherein
the at least one processor performs a speech recognition processing to convert a phone conversation into a string, and
when an input done by operating the input apparatus during the voice call is valid, the at least one processor corrects an input string contained in text input by operating the input apparatus, based on a sound string contained in a phone conversation recognized in the speech recognition processing.

12. The mobile phone according to claim 11,
wherein the at least one processor
designates, as the sound string, a string uttered a first number of times or more in a past phone conversation, and
designates, as the sound string, a string uttered a second number of times or more in a phone conversation that is ongoing when the text is input from the input apparatus, the second number of times being less than the first number of times.

13. A method for operating a mobile phone, the method comprising:
receiving information from an input apparatus external to the mobile phone;
detecting an object in proximity;
performing a voice call with a first phone apparatus external to the mobile phone; and
enabling an input from the input apparatus when the object in proximity is detected and the voice call is performed.

14. A non-transitory computer readable recording medium that stores a control program for controlling a mobile phone, the control program causing the mobile phone to execute:
receiving information from an input apparatus external to the mobile phone;
detecting an object in proximity;
performing a voice call with a first phone apparatus external to the mobile phone; and
enabling an input from the input apparatus when the object in proximity is detected and the voice call is performed.
